(19) United States
(12) Patent Application Publication
(10) Pub. No.: US 2007/0214042 A1
(43) Pub. Date: Sep. 13, 2007

(54) Advertising triggered by sequences of user actions

(75) Inventor: Ewa Dominowska, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/374,213

(22) Filed: Mar. 13, 2006

(51) Int. Cl. G06Q 30/00

(52) U.S. Cl. 705/14

(57) ABSTRACT

Selecting advertisements for presentation based on user actions on a computing device is provided. The selected advertisements are associated with products or services that enable or enhance tasks that a user may be attempting to perform on the user device. User actions on the computing device are tracked, and tasks that a user is likely attempting to perform are determined based on the tracked user actions. A determination is also made regarding whether any of these likely tasks are not currently enabled or may be enhanced. Advertisements are then selected and presented for tasks that are not currently enabled or may be enhanced.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Advertising within software applications has become an increasing source of revenue. In particular, many software providers have turned to integrating advertisements within their software applications for the purposes of revenue generation. The revenue from fees paid by advertisers often allows software providers to offer software applications to users at a reduced price or even free of charge in some cases.

Currently, such advertising typically entails presenting large, randomly-selected graphical advertisements to users, for example, within a panel of the graphical user interface of the software applications. It is the advertisers' goal to maximize conversions (i.e., users purchasing products or subscribing to services from the advertisements). However, users often perceive the advertisements as distracting and interfering, resulting in low user satisfaction. Moreover, because the randomly selected advertisements are not effectively targeted, users are often not interested in the products or services offered, resulting in low conversion rates.

Some operating systems and software applications have been moving toward a user-centric design model as opposed to, for example, a system-centric design. One outcome of this shift has been the introduction and use of tasks. A task may be defined as a grouping of user actions that is commonly repeated and results in a successful achievement of a user goal. For example, in some applications, a preview-pane may be is used to display commonly available tasks. These tasks are related to the current system state and other recently performed actions or tasks. For example, if a user has navigated to a window with a directory full of MP3 files, the tasks may include, for instance: play the file, add the file to a play list, and play a snippet of the file. As another example, if the user is viewing a list of contacts, the tasks may include, for instance: e-mail this contact, send a chat message to this contact, and call this contact on the phone. Each task typically consists of a grouping of simpler actions, such as clicking on buttons or choosing from menus, for example.

In some cases, however, some tasks might not be enabled because of missing hardware or software. For example, in the context of a user navigating to a list of MP3 files, one task may be to play an MP3 file. If the user device does not have an MP3 decoder installed, the task to play the MP3 file will not be enabled. In other cases, some currently enabled tasks may be further enhanced, for instance, by installing improved hardware or software. For example, a user may navigate to an area for selecting video games. Although the user device may have a graphics card, other graphic cards may be available that provide an improved user experience while playing such games. Often, however, users may not know how to quickly or efficiently enable or enhance such tasks.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In embodiments, advertisements may be selected for presentation based on user actions within a computing environment. Advertisements may be selected and presented to a user if the products or services associated with the advertisements would enable or enhance a task that a user may be attempting to perform. As a user performs a sequence of actions, the user actions are tracked, and most likely action paths (e.g., each path comprising a task) are identified. Upon identification of the most likely tasks that a user may wish to perform, those tasks that are not currently enabled or that may be enhanced are determined. Such “non-enabled” tasks or “enhanceable” tasks may be identified by accessing global system information for the user's computing device, including such information as installed software, installed hardware, current system state, and current service subscriptions. Advertisements associated with products or services that would enable the non-enabled tasks or enhance the enhanceable tasks are selected and presented to the user. A user may act based on an advertisement in order to access and/or purchase an associated product or service, thereby enabling or enhancing a task.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is block diagram of an exemplary system for selecting and presenting advertisements based on user actions in accordance with an embodiment of the present invention

FIG. 3 a flow diagram showing an exemplary method for selecting an advertisement based on user actions in accordance with an embodiment of the present invention;

FIG. 4 is a flow diagram showing an exemplary method for enabling or enhancing a task using an advertisement selected based on user actions in accordance with an embodiment of the present invention;

FIG. 5 is an illustrative screen display of an exemplary user interface presenting advertisements in accordance with an embodiment of the present invention;

FIG. 6 is another illustrative screen display of an exemplary user interface presenting advertisements in accordance with an embodiment of the present invention; and

FIG. 7 is a further illustrative screen display of an exemplary user interface presenting advertisements in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide for the selection and presentation of advertisements based on user actions on a computing device. When a user works on his/her computing device, each action sequence performed is matched against a statistical task model to determine tasks that the user is most likely attempting to perform. The system also determines whether the user is not able to complete any of these tasks or if any of the tasks may be further enhanced. These tasks may be referred to herein as “non-enabled” tasks or “enhanceable” tasks, respectively. Advertisements associated with products or services that would enable the non-enabled tasks or enhance the enhanceable tasks are selected and presented to the user. In some embodiments, the advertisements may be presented at a location where the user would expect to complete the associated tasks. The user may then select an advertisement to access further information regarding the product or service and choose whether to purchase the product or service. If a conversion is made and the product or service is installed on the user's computing device (for physical devices, installation might be delayed until the user receives the device and connects it to the original computing device), the system state of the computing device is updated, and the task is accordingly enabled or enhanced for the user.

Accordingly, embodiments of the present invention provide an approach for selecting and presenting advertisements that are appropriately targeted and timely presented. If a user is attempting to achieve a goal that is not currently enabled or may be enhanced, advertisements are selected and presented to provide the user with information that will allow the user to obtain the necessary hardware, software, or service that will enable or enhance the task the user is attempting to perform. As such, the user is more likely to purchase the advertised product or service.

As used herein, the term “advertisement” is intended to be used in the broadest sense. Advertisements in accordance with embodiments of the present invention are not limited to traditional usage, such as a presentation of images or text descriptions of products or services offered by advertisers. Instead, an advertisement may comprise any means of promoting a product or service, thereby allowing a user to access further information and/or to purchase the product or service. For instance, an advertisement may simply consist of presenting a task itself (e.g., “Print this image”) and including an embedded link to allow a user to access further information regarding products or services and potentially complete a conversion.

Accordingly, in one aspect, an embodiment of the present invention is directed to a method for utilizing user actions on a computing device to select advertisements for presentation. The method includes tracking user actions on a computing device and determining tasks that a user is likely to attempt to perform based on the user actions. The method also includes determining that at least one of the tasks is not enabled or is capable of being enhanced. The method further includes selecting an advertisement for presentation, wherein the advertisement is associated with a product or service that enables or enhances the tasks that is not enabled or is capable of being enhanced. The method still further includes presenting the advertisement.

In another aspect of the invention, an embodiment is directed to a method for enabling or enhancing a task on a computing device. The method includes determining that a task a user may be attempting to perform on the computing device is not enabled or is capable of being enhanced. The method also includes selecting an advertisement based on the task, wherein the advertisement is associated with a product or service that enables or enhances the task. The method further includes displaying the advertisement, wherein the displayed advertisement is user-selectable and provides for a conversion when selected by a user. The method also includes receiving a user selection of the displayed advertisement. The method further includes determining that a product or service that enables or enhances the task has been installed on the computing device. The method still further includes enabling or enhancing the task on the computing device.

In a further embodiment of the present invention, a system for selecting advertisements for presentation based on user actions within a computing device is provided. The system includes a watcher component, a system state component, an advertisement selection component, and an advertisement presentation component. The watcher component is capable of tracking user actions on the computing device and determining likely tasks based on the user actions. The system state component is capable of accessing global system information associated with the computing device and determining a likely task that is not enabled or is capable of being enhanced based on the global system information. The advertisement selection component is capable of selecting an advertisement based on the likely task that is not enabled or may be enhanced. The advertisement presentation component is capable of presenting the advertisement.

Embodiments of the present invention may be employed for revenue generation in a number of different ways. For example, each time an advertisement is displayed to a user, the appropriate advertiser may be charged a fee (e.g., the application selecting and displaying the advertisement may charge the appropriate advertiser). Additionally or alternatively, each time a user interacts with an advertisement (e.g., selects an advertisement, clicks on a link, activates an element of the advertisement, etc.), the appropriate advertiser may be charged a fee. Further, each time a user conversion is completed, the appropriate advertiser may be charged a fee. A logging component may track advertisements being displayed, user interaction with advertisements, and user conversions such that advertisers may be appropriately charged.

Having briefly described an overview of the present invention, an exemplary operating environment for the present invention is described below.

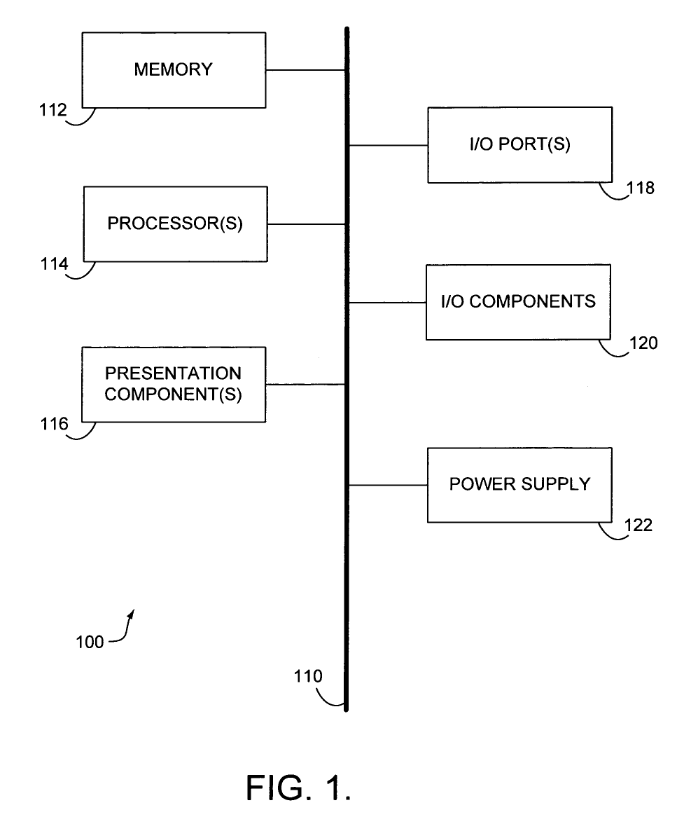

Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

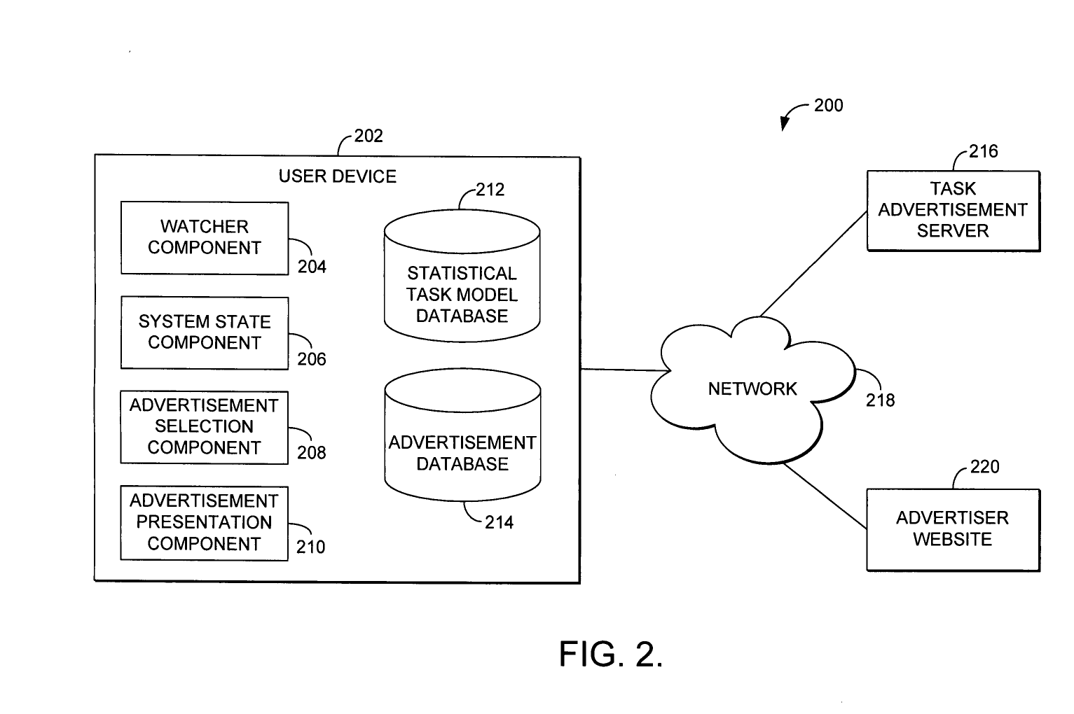

Referring now to FIG. 2, a block diagram is illustrated that shows an overall system architecture 200 for selecting and presenting advertisements based on user actions performed on a user device 202 in accordance with an embodiment of the present invention. The selected advertisements are associated with products and/or services that may enable or enhance a task that the user may be attempting to perform. It will be understood and appreciated by those of ordinary skill in the art that the overall system architecture 200 shown in FIG. 2 is merely an example of one suitable computing environment and is not intended to suggest any limitation as to the scope of use or functionality of the present invention. Neither should the overall system architecture 200 be interpreted as having any dependency or requirement relating to any single component or combination of components illustrated therein.

The user device 202 shown in FIG. 2 may be any type of computing device, such as, for example, computing device 100 described above with reference to FIG. 1. By way of example only and not limitation, the user device 202 may be a user's personal computer, desktop computer, laptop computer, handheld device, consumer electronic device, and the like. It should be noted, however, that the invention is not limited to implementation on such computing devices, but may be implemented on any of a variety of different types of computing devices within the scope of the present invention.

As shown in FIG. 2, a number of components may reside on the user device 202 for implementing embodiments of the present invention, including a watcher component 204, system state component 206, an advertisement selection component 208, an advertisement presentation component 210, a statistical task model database 212, and an advertisement database 214. In some embodiments, the components may be implemented as a stand-alone application that consumes task sequences from different applications. In other embodiments, the components may be integrated directly into the operating system for the user device 202.

The watcher component 204 may be provided for tracking user actions on the user device 202 and determining the tasks that the user is most likely attempting to perform. The watcher component 204 may track user actions, for example, by accessing information such as current system state, currently running software, and active applications. The user actions may then be compared against statistical task models, which may be stored on the user device 202 in a statistical task model database 212, to determine the tasks that the user is most likely attempting to perform. The statistical task models allow for the prediction of likely action path completions based on computed likelihoods of action paths. The statistical task models may include tasks that have been modeled statistically, as well as tasks that have been manually defined via a set of rules.

The watcher component 204 may further be capable of collecting statistical path aggregates comprising information representing the most common ways the user employs his/her computing device, such as the most common goals the user attempts to achieve and the most common ways the user attempts to achieve the goals. The aggregates may be used to identify and author common tasks for the user. For example, the aggregates may be communicated to a task advertisement server 216 (e.g., via network 218) and used to generate further statistical task models of likely action paths. In some cases, statistical path aggregates collected from multiple users may be used for generating further statistical task models. The further statistical task models may then be communicated to the user device 202 and stored in the statistical task model database 212, thereby allowing further tasks to be identified based on various user action sequences.

The user device 202 may also include a system state component 206 for accessing global system information and determining tasks that are not currently enabled or that may be enhanced. For example, the system state component 206 may be able to access information regarding hardware and software currently installed on the user device 202. In addition, the system state component 206 may be able to access information regarding services (e.g., web-services, subscription-based models, and user and system accounts for services) that may be available to the user device 202. Based on the global system information, the system state component 206 or another associated component may determine whether any of the tasks that the user may be attempting to perform cannot be completed (i.e., “non-enabled” tasks) because of missing hardware, software, or subscription services. In addition, the system state component 206 or another associated component may determine whether any of the tasks that the user may be attempting to perform may be enhanced (i.e., “enhanceable” tasks). To perform such determinations, the system state component 206 or associated component may access information regarding the likely tasks, including information regarding the necessary system components and/or services required to perform those tasks and compare such information against global system information.

The system 200 may further include an advertisement selection component 208 for selecting advertisements for any identified non-enabled tasks and enhanceable tasks. To perform such selection, the advertisement selection component 208 may access advertisement information, which may include information corresponding advertisements with particular tasks and/or with products or services that may enable or enhance tasks, as well as base information about the nature of the advertisement and information on expected revenue. The advertisement information may further include links to access the products and/or services offered by advertisers. For example, a link to an advertiser's webpage may be associated with an advertisement.

In some embodiments, the advertisement selection component 208 may access the advertisement information from a remote computing device (e.g., via network 218), such as the task advertisement server 216, for example, each time an advertisement is selected. In other embodiments, such as that shown in FIG. 2, advertisement information may be stored on the user device 202, for example, in an advertisement database 214. In such embodiments, the task advertisement server 216 may periodically communicate advertisement information to the user device 202 for updating the information stored in the advertisement database 214. At the same time, the user device 202 can upload performance logging and tracking information to a central server, such as the task advertisement server 216.

Advertisement information stored in the advertisement database 214 and/or the task advertisement server 216 may be generated in a variety of ways within the scope of the present invention. Typically, advertisers provide advertisements targeted at specific products or services that may enable or enhance a task. Generally, various products and services may be identified as corresponding with common user tasks. Each advertiser may specify the product and/or service that the advertiser may provide or the task that the advertiser may facilitate, allowing for each advertisement to be associated with an appropriate task. In some embodiments, advertisement bidding services may be employed for selecting advertisements corresponding with specific tasks. In further embodiments, after identifying product or service features that may enable or enhance tasks, web crawls may be performed for collecting information from websites regarding specific products and services. Advertisements may then be generated from the collected information.

After advertisements have been selected for non-enabled and/or enhanceable tasks, the selected advertisements may be presented via an advertisement presentation component 210. Typically, presentation of an advertisement comprises displaying the advertisement on a display device associated with the user device 202. However, other types of presentation, such as an audible presentation, may also be provided within the scope of the present invention. In some embodiments, an advertisement may be presented in a user interface at a location expected for task continuation. In other words, an advertisement may be presented in the context of the currently used application at a location where a user would turn his/her attention to complete the associated task if the task were already enabled or enhanced. Accordingly, an advertisement may be displayed in a preview pane, menu, explorer bar, dialog box, button, or the like, where a user would expect to compete the task that the advertisement enables or enhances. In some cases, an advertisement may be presented as a traditional advertisement, providing information such as a product or service offered and the product/service provider. In other embodiments, an advertisement may be presented to appear as the associated task with some indication allowing the user to recognize that the task is not currently enabled or may be enhanced.

An advertisement displayed within a user interface on the user device 202 may further include an embedded link allowing a user to access further information and/or to enable or enhance the associated task by completing a conversion. For example, an advertisement may include a link to an advertiser's webpage 220. By selecting the advertisement, the user may be navigated to the webpage 200. The webpage 220 may provide further information regarding the product or service offered and may allow the user to purchase the product or service. In some embodiments, an embedded link may be provided that allows the user to purchase a product or service without having to navigate to the advertiser's website (e.g., by providing for a “one-click” conversion).

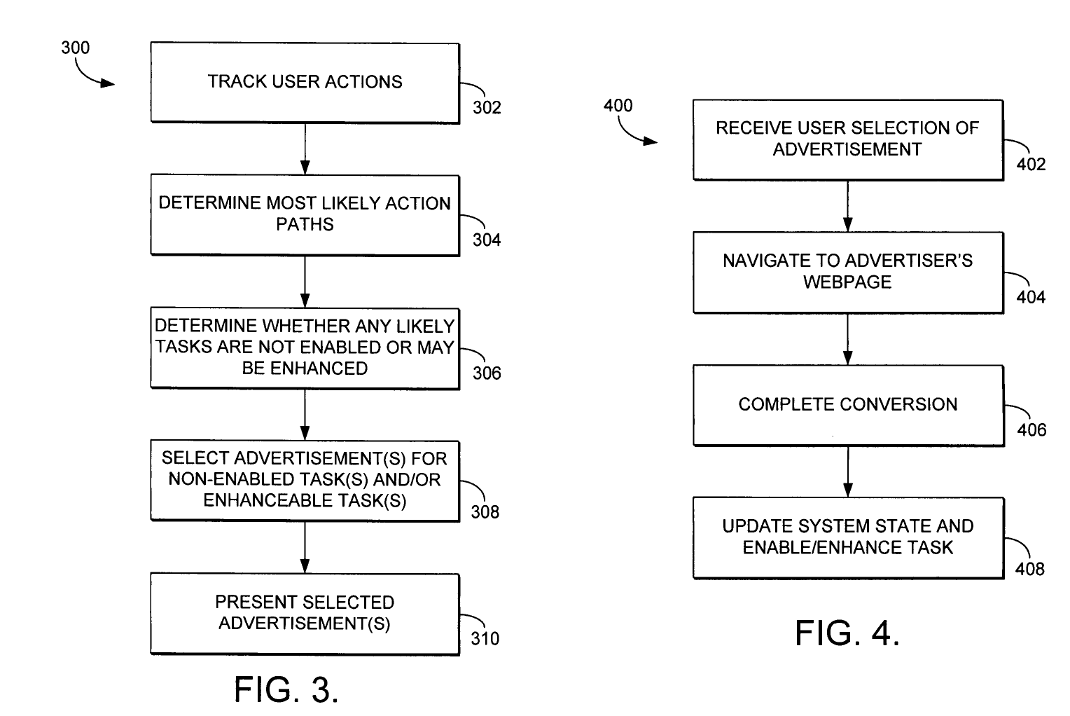

Turning to FIG. 3, a flow diagram is illustrated that shows an exemplary method 300 for selecting and presenting advertisements based on user actions in accordance with an embodiment of the present invention. Initially, when a user works on a computing device, such as the user device 202 of FIG. 2, user actions are tracked as shown at block 302.

Based on the tracked user actions, the most likely action paths (e.g., most likely tasks) that the user may be attempting to perform may be determined, as shown at block 304. The determination of likely tasks may include accessing statistical task models, such as those stored by the statistical task model database 214 of FIG. 2, and comparing the user actions against the statistical task models to determine tasks that the user most likely may be attempting to perform.

A determination may also be made regarding whether any of the tasks identified at block 304 are not currently enabled or may be enhanced, as shown at block 306. The identification of such non-enabled or enhanceable tasks may include accessing global system information regarding the user's computing device, including such information as installed hardware, installed software, and currently available service subscriptions.

If any of the likely tasks are identified as not being currently enabled or are otherwise enhanceable, an advertisement for at least one of the identified non-enabled tasks and/or enhanceable tasks is selected, as shown at block 308. A catalog or list of advertisements, such as either a local database stored on the user device (e.g., the advertisement database 214 of FIG. 2) or a remote database communicating with the user device (e.g., the task advertisement server 216 of FIG. 2), may be accessed for selection of appropriate advertisements. In addition, in some embodiments, a web crawl may be performed to access information for the generation of an advertisement. In various embodiments, either a single advertisement or multiple advertisements may be selected and presented for each non-enabled and enhanceable task. Additionally, in some embodiments, the selection of advertisements may incorporate other considerations. For example, in the context of an advertisement for printing photos, if the system detects that the user has a camera from a particular manufacturer, the system may correspondingly select an advertisement for a printer from the same manufacturer.

Finally, as shown at block 310, selected advertisements are presented to the user. Presentation of the selected advertisements may be accomplished in a variety of different ways within the scope of the present invention. Typically, the presentation includes displaying the advertisements within a graphical user interface. By way of example only and not limitation, selected advertisements may be displayed within a preview pane, a menu, a dialog box, a button, an explorer bar, or any other user interface element intended for invoking a command or action. In some embodiments, each advertisement may be displayed in the context of a currently used application at a location where the user would turn his/her attention to complete the task if the task were enabled and/or enhanced.

Referring now to FIG. 4, a flow diagram is provided illustrating a method 400 for enabling and/or enhancing a task via an advertisement selected and presented based on user actions in accordance with an embodiment of the present invention. Initially, as shown at block 402, a user selects an advertisement that has been presented based on the user's actions. As discussed previously, the advertisement may be associated with a product or service that may enable or enhance a task that the user may be attempting to perform. The advertisement may have been selected and presented, for instance, similar to that described for method 300 and with reference to FIG. 3.

In the present embodiment, the displayed advertisement includes an embedded link to an advertiser's webpage. Accordingly, as shown at block 404, by selecting the advertisement, the user is navigated to the advertiser's webpage (e.g., by automatically opening a web browser on the user device and using the browser to navigate to the webpage). As indicated previously, in other embodiments, the advertisement may provide one-click conversion, allowing a user to purchase a product or service without navigating to the advertiser's webpage. For example, the advertisement may comprise an application that self-enables the conversion.

After navigating to the advertiser's webpage, the user may review information regarding the product or service the advertiser is offering. Additionally, the user may decide to purchase the product or service. Accordingly, a conversion is completed for the advertised product or service, as shown at block 406.

After a user completes the conversion, and the purchased product or service has been installed on the user device, the internal state of the system is updated as shown at block 408. Additionally, the task is enabled or enhanced in accordance with the newly installed product or service. In the case of software applications and service subscriptions that may simply be downloaded to the user device after a conversion, the system may be updated and the task enabled or enhanced substantially simultaneously with the conversion. In the case of hardware purchases and the like, the system would not be updated and the task would not be enabled/enhanced until the user receives and installs the hardware.

The methods 300 and 400 of selecting and presenting advertisements based on user actions and enabling or enhancing tasks via such advertisements described above with reference to FIG. 3 and FIG. 4 may now be further illustrated with an example. A user may have downloaded pictures from his/her digital camera, opened one of the pictures in a photo editing software, and performed edits on the photo. Accordingly, this action sequence would be tracked by the system (block 302). Based on the tracked user actions, a determination may be made that the most likely tasks to complete this sequence of actions include printing the edited photograph and sending the photo to an online photo development center (block 304). However, the system may detect that a printer is not connected to the user's computing device, that a printer driver is not installed, and/or that the user does not currently have a subscription to an online photo development center (block 306). Accordingly, the system may select one or more advertisements for a printer, printer driver, and/or online photo development service (block 308) and present the advertisements to the user (block 310). As mentioned previously, in some embodiments, advertisements may be presented at a location where the user would expect to complete corresponding tasks. For example, the photo editing software in which the user is working may include a preview pane (or task pane) for listing tasks. The user would expect to turn to the preview pane to print the image (e.g., by selecting a “Print this image” option in the preview pane). Accordingly, advertisements for printers, printer drivers, and online photo development services may be presented at this location in the preview pane. Additionally, as mentioned previously, in some embodiments, the advertisement may simply be presented as the task option (e.g., “Print this image”) within the preview pane with some indication that the task is an advertisement (e.g., using a specific text color).

The user may review the advertisements presented and decide to inquire further regarding the advertised products or services. For example, the user may review an advertisement for a printer and wish to access further information. Accordingly, the user may select the advertisement; for example, by clicking on the displayed advertisement (block 402). The advertisement includes an embedded link, which navigates the user to the advertiser's webpage (block 404). As such, the user may access further information regarding the advertiser's printers and decide to purchase a printer (block 406). Once the user receives and installs the printer, the corresponding task to print will be enabled (block 408).

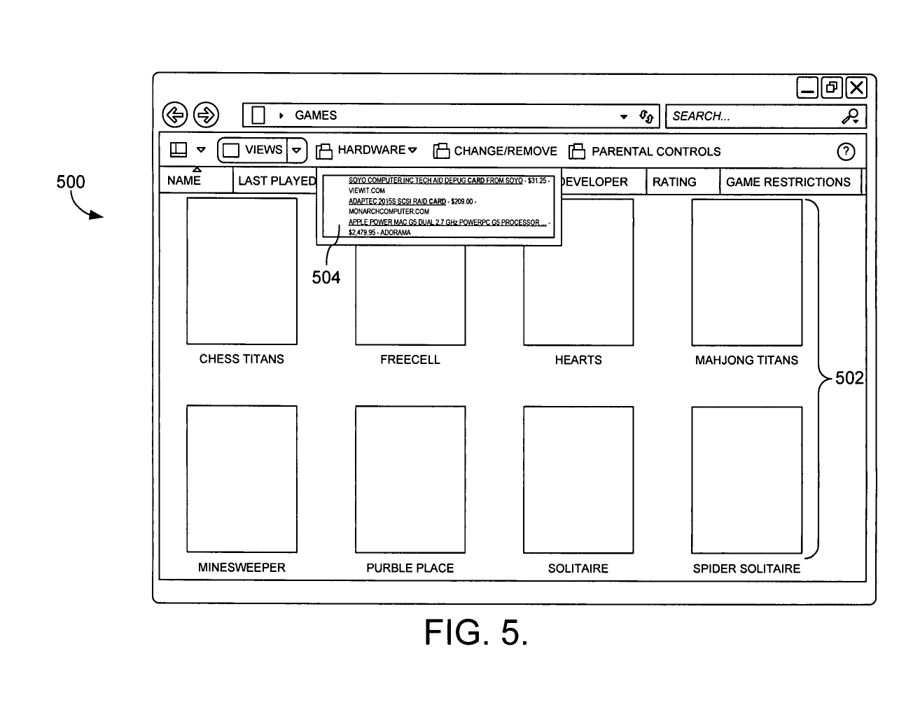

FIG. 5 through FIG. 7 provide illustrative screen displays of user interfaces presenting advertisements in accordance with embodiments of the present invention. It will be understood and appreciated by those of ordinary skill in the art that the user interfaces 500, 600, and 700 illustrated in FIG. 5 through FIG. 7 are shown by way of example only and are not intended to limit the scope of the invention in any way.

Referring initially to FIG. 5, a screen display is depicted in which a user has navigated to a user interface 500 for accessing games 502. Accordingly, the system may determine that the user would likely attempt to play one of the games. However, the system may also determine that the user device is not currently capable of running the games because of hardware deficiencies. As such, the system may select and present, in the dialog box 504, a number of advertisements for hardware items that may allow the user to run the games.

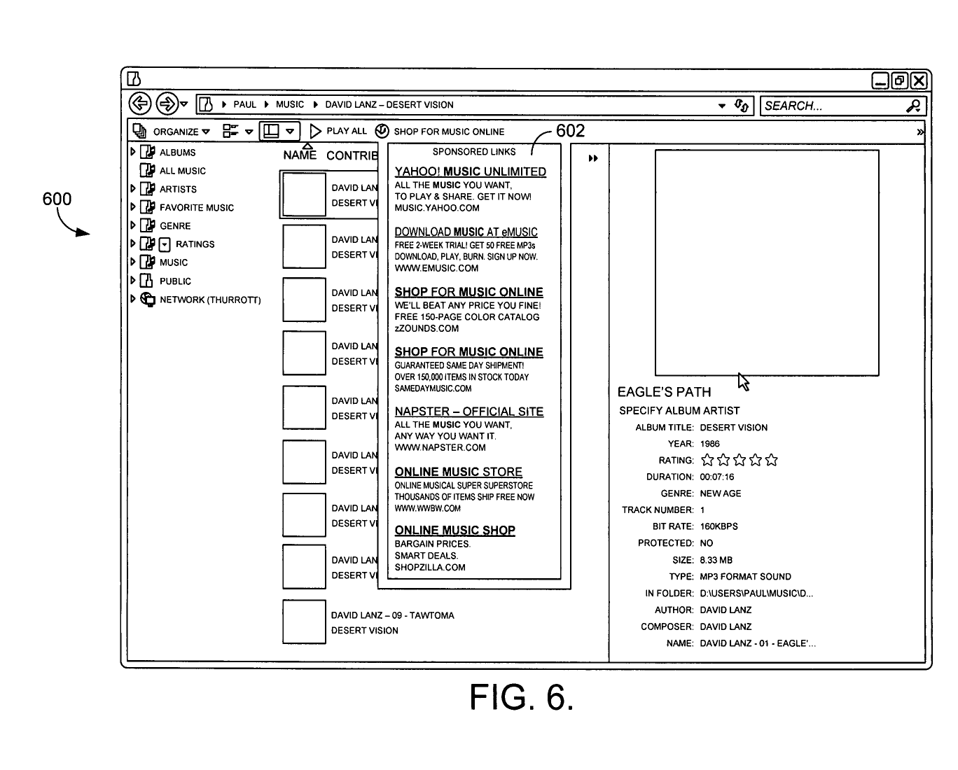

The screen display shown in FIG. 6 provides an illustration of a user display 600 in which the user may access music files. For example, the user may have navigated to the user display 600 and may be listening to MP3 files stored on the user device. Based on the user actions, the system may determine that a task that the user may likely attempt to perform would be to purchase music online. Accordingly, the system has selected and presented a number of advertisements for online music shopping in a preview pane 602.

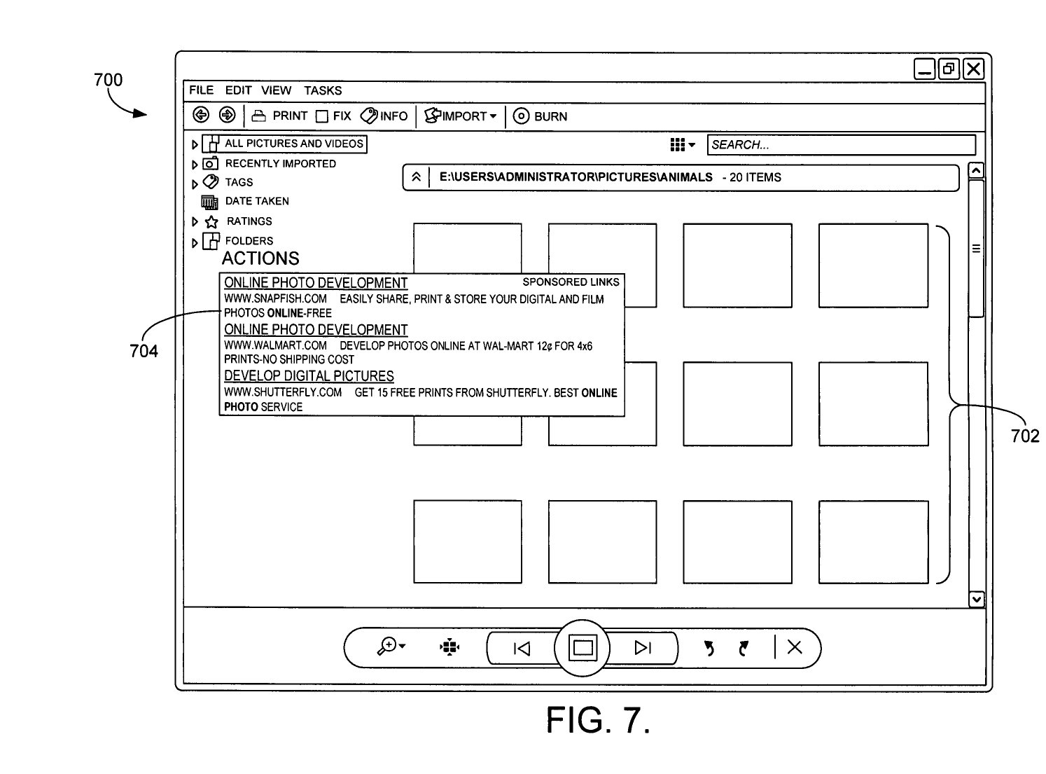

Finally, in the screen display shown in FIG. 7, a user has navigated to a user interface 700 for accessing and viewing photos 702 stored on the user device. For example, the user may have downloaded photos 702 from a digital camera and may be viewing the photos in the user display 700. The system may determine based on these user actions that a likely task that the user would like to perform would be to send one or more of the photos 702 to an online photo development center. Additionally, the system may determine that the user does not currently have any particular online photo development service subscriptions. As such, the system has selected and presented a number of advertisements for online photo development services in a preview pane 704 of the user interface 700.

As can be understood, embodiments of the present invention provide for the selection and presentation of advertisements associated with products or service that enable or enhance tasks that the user is likely attempting to perform. Further embodiments of the present invention provide for enabling and enhancing tasks via conversions from such advertisements.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for utilizing user actions on a computing device to select advertisements for presentation, the method comprising:
tracking user actions on a computing device;
determining one or more tasks that a user is likely to attempt to perform based on the user actions;
determining that at least one of the one or more tasks is not enabled or is capable of being enhanced;
selecting at least one advertisement for presentation, wherein the at least one advertisement is associated with a product or service that enables or enhances the at least one of the one or more tasks that is not enabled or is capable of being enhanced; and
presenting the at least one advertisement.

2. The method of claim 1, wherein determining one or more tasks that a user is likely to attempt to perform based on the user actions comprises:
accessing one or more statistical task models; and
comparing the user actions against the statistical task models to determine the one or more tasks that the user is likely to attempt to perform.

3. The method of claim 1, wherein determining that at least one of the one or more tasks is not enabled or is capable of being enhanced comprises:
accessing global system information for the computing device; and
determining that at least one of the one or more tasks is not enabled or is capable of being enhanced based on the global system information.

4. The method of claim 3, wherein the global system information for the computing device comprises information regarding at least one of installed hardware, installed software, and a service subscription.

5. The method of claim 1, wherein selecting at least one advertisement for presentation comprises accessing an advertisement catalog storing one or more advertisements, the advertisement catalog being stored on at least one of the computing device and a remote computing device.

6. The method of claim 5, wherein the advertisement catalog comprises information associating at least one task with at least one advertisement.

7. The method of claim 5, wherein the advertisement catalog comprises information associating at least one task with at least one of a product and a service that enables or enhances the at least one task.

8. The method of claim 1, wherein presenting the at least one advertisement comprises displaying the advertisement within a user interface displayed on a display device associated with the computing device.

9. The method of claim 8, wherein displaying the at least one advertisement comprises displaying the at least one advertisement at a location within the user interface at which the user would expect to complete the at least one of the one or more tasks that is not enabled or is capable of being enhanced if the at least one of the one or more tasks was enabled or enhanced.

10. The method of claim 9, wherein the location at which the at least one advertisement is displayed comprises at least one of a preview pane, a menu, a dialog box, an explorer bar, and a button.

11. The method of claim 1, wherein the at least one advertisement links to at least one of a webpage and an application allowing a user to complete a conversion.

12. One or more computer-readable media having computer-useable instructions embodied thereon for performing the method of claim 1.

13. A method for enabling or enhancing a task on a computing device, the method comprising:
determining that a task a user may be attempting to perform on the computing device is not enabled or is capable of being enhanced;
selecting an advertisement based on the task, wherein the advertisement is associated with a product or service that enables or enhances the task;
displaying the advertisement, wherein the displayed advertisement is user-selectable and provides for a conversion when selected by a user;
receiving a user selection of the displayed advertisement;
determining that a product or service that enables or enhances the task has been installed on the computing device; and
enabling or enhancing the task on the computing device.

14. The method of claim 13, wherein in response to receiving a user selection of the displayed advertisement, the method further comprises navigating to a webpage providing for a conversion.

15. The method of claim 13, wherein displaying the advertisement comprises displaying the advertisement at a location within a user interface where a user would expect to complete the task.

16. One or more computer-readable media having computer-useable instructions embodied thereon for performing the method of claim 13.

17. A system for selecting advertisements for presentation based on user actions within a computing device, the system comprising:
at least one watcher component for tracking user actions on the computing device and determining likely tasks based on the user actions;
at least one system state component for accessing global system information associated with the computing device and determining at least one likely task that is not enabled or is capable of being enhanced based on the global system information;
at least one advertisement selection component for selecting at least one advertisement based on the at least one likely task that is not enabled or is capable of being enhanced; and
at least one advertisement presentation component for presenting the at least one advertisement.

18. The system of claim 17, further comprising a statistical task model database for storing one or more statistical task models, wherein the at least one watcher component is capable of accessing the one or more statistical task models for determining likely tasks.

19. The system of claim 17, further comprising an advertisement database for storing information associating at least one task with at least one of a product, a service, and an advertisement, wherein the at least one advertisement selection component is capable of accessing the at least one advertisement database for selecting the at least one advertisement.

20. The system of claim 17, wherein the at least one advertisement presentation component displays the at least one advertisement at a location within a user interface where a user would expect to complete the at least one likely task that is not enabled or is capable of being enhanced if the at least one likely task were enabled or enhanced.
